(19) United States
(12) Patent Application Publication
(10) Pub. No.: US 2008/0006236 A1
(43) Pub. Date: Jan. 10, 2008

(54) Control system for engine with auxiliary device and related engine control method

(75) Inventors: Yukihiro Yamashita, Takahama-shi (JP); Kazuyoshi Obayashi, Chita-gun (JP); Keisuke Tani, Anjo-shi (JP); Katsunori Tanaka, Aichi-ken (JP); Takeshi Shimoyama, Kariya-shi (JP); Naoki Yamamoto, Chita-gun (JP)

Correspondence Address: NIXON & VANDERHYE, PC, 901 NORTH GLEBE ROAD, 11TH FLOOR, ARLINGTON, VA, 22203, US

(73) Assignee: DENSO CORPORATION, Kariya-city (JP)

(21) Appl. No.: 11/806,570

(22) Filed: Jun. 1, 2007

(30) Foreign Application Priority Data
Jul. 6, 2006 (JP) 2006-186245

(51) Int. Cl. F02D 29/00; B60K 25/00

(52) U.S. Cl. 123/198 R

(57) ABSTRACT

An engine control method and related engine control method are disclosed for an engine with an auxiliary device of a vehicle wherein auxiliary device control means controls a drive torque of the auxiliary device, engine control means executes an engine torque control to vary the output torque of the engine, and failure detecting means detects a failure giving an adversely affect to engine torque control executed with the engine control means. The auxiliary device control means alters a drive control mode of the auxiliary device in response to the failure detected with the failure detecting means. In preferred embodiment, the auxiliary device is driven in a collaborative control mode in the presence of an extremely mild failure, a fixed voltage control mode in the presence of a mild failure and a gradual change control mode in the presence of a fatal failure.

### CROSS REFERENCE TO RELATED APPLICATIONS

This application is related to Japanese Patent Application No. 2006-186245, filed on Jul. 6, 2006, the content of which is hereby incorporated by reference.

### BACKGROUND OF THE INVENTION

1. Technical Field of the Invention

The present invention relates to control systems for engines with auxiliary devices and, more particularly, to a control system for an engine with an auxiliary device which has a function to control drive torque of an auxiliary device driven with output torque (hereinafter referred to as “engine torque”) of the engine.

2. Description of the Related Art

A modern vehicle is installed with various engine-driven auxiliary devices such as, for instance, an alternator, an air-conditioning compressor, a power steering compressor, a motor generator, a booster pump for raising a fuel pressure, and an oil pump, etc.

These auxiliary devices are driven with engine torque. Therefore, as drive torque (that is, among engine torque, torque consumed with the auxiliary device) of the auxiliary device rapidly fluctuates during an operating condition of an engine, an unpleasant fluctuation takes place in an engine speed especially during an idling state with a less degree of demanded engine torque.

To address such an issue, an attempt has heretofore been made to provide an engine speed control device with such a structure as disclosed in Japanese Patent No. 2890586. With such a related art, a fluctuation in torque is detected, upon which an intake-air volume and an electric power-generating rate of an alternator are controlled in an organized correlation depending on the fluctuation in torque. Such control is executed to lower the electric power-generating rate of the alternator for a time period in which a shortage of the intake-air volume fails to be compensated in time, thereby causing the engine speed to be stabilized.

Meanwhile, if a failure occurs in systems such as, for instance, a fuel injection system, an ignition system and intake-air-intake system, etc., which control engine torque, it becomes hard to normally control engine torque. Under such a failed status, if such organized control disclosed in the related art mentioned above is continued, a further increased fluctuation inevitably takes place in the engine speed during idling of the engine. This results in the occurrence of an engine stall, causing an acceleration or deceleration of a vehicle to occur against a driver's will during a traveling of the vehicle.

### SUMMARY OF THE INVENTION

The present invention has been completed with the above view in mind and has an object to provide a control system for an engine with an auxiliary device, which can drive the auxiliary device so as to minimize an adverse affect of a failure given to engine torque control in the presence of a failure adversely affecting engine torque control, and a method of controlling an engine with an auxiliary device for properly controlling the engine at an optimum efficiency even in the presence of a failure in a system adversely affecting engine torque control.

To achieve the above object, a first aspect of the present invention provides a control system for an engine with an auxiliary device, driven with an output torque of the engine, for driving a vehicle. The control system comprises auxiliary device control means for controlling a drive torque of the auxiliary device, engine control means for executing an engine torque control to vary the output torque of the engine, and failure detecting means for detecting a failure, related to an operating parameter of the engine, which adversely affect engine torque control being executed with the engine control means. The auxiliary device control means alters a drive control of the auxiliary device in response to the failure detected with the failure detecting means.

With such a structure of the control system, the failure related to the operating parameter adversely affecting engine torque control is detected. Then, at a time instant when the failure is detected, the drive control of the auxiliary device is altered. This makes it possible to minimize the adverse affect given to the engine control. Thus, the auxiliary device can be driven while minimizing the adverse affect of the failure given to engine torque control.

With the control system for the engine, the auxiliary device may preferably include at least one of an alternator, an air-conditioning compressor, a power-steering compressor and a motor generator.

These auxiliary devices need to have relatively large drive torques and drive torque of the auxiliary device has a strong relation with engine torque control of the engine. When the failure adversely affecting engine torque control is detected, if the auxiliary device drive control is continued in the same manner as that achieved in a normal mode in the absence of the failure, engine torque control significantly undergoes the adverse affect of the failure. Thus, the drive control of the auxiliary device is effectuated in an altered mode to address such an issue.

With the control system for the engine of the present embodiment, further, the auxiliary device control means may preferably perform a collaborative control for varying drive torque of the auxiliary device in accordance with the output torque of the engine during a time period in which no failure is detected with the failure detecting means.

By so doing, when no failure is detected with the failure detecting means, the collaborative control can be performed to vary drive torque of the auxiliary device so as to allow the vehicle to be driven with a demanded vehicle drive torque even if a rapid change occurs in a demanded auxiliary-device drive torque. This makes it possible to suppress an undesired fluctuation of an engine speed while preventing the vehicle from accelerating or decelerating against a driver's will during the rapid change in the demanded auxiliary-device drive torque.

With the control system for the engine of the present embodiment, furthermore, the auxiliary device control means may preferably alter a control mode to a gradual change control mode for varying drive torque of the auxiliary device at a slower rate than that achieved in a normal mode during variation in a demanded auxiliary-device drive torque when the failure is detected with the failure detecting means.

By so doing, even if the rapid change occurs in the demanded auxiliary-device drive torque in the presence of the failure, the gradual change control mode enables drive torque of the auxiliary device to gradually vary at a slower rate than that achieved in the normal mode. This prevents the fluctuation of the engine speed and the acceleration or deceleration of the vehicle from increasing due to the rapid change in drive torque of the auxiliary device.

With the control system for the engine of the present embodiment, moreover, the auxiliary device may preferably comprise an alternator, and the auxiliary device control means may preferably execute at least one of a gradual change in electric power generated by the alternator, a gradual change in an excitation current of the alternator, a gradual change in a power-generating command duty and a gradual change in a demanded power-generating torque.

With such a structure of the control system, any of these gradual changes enables the avoidance of a rapid change in drive torque of the alternator during the occurrence of the failure in the operating parameter of the engine.

With the control system for the engine of the present embodiment, further, the auxiliary device control means may preferably alter a gradual change speed of the gradual change control mode depending on a severity of the failure being detected with the failure detecting means.

With such an operation, drive torque of the auxiliary device can be varied such that the more severe the severity of the failure, the slower will be the gradual change speed of the gradual change control mode. This results in a capability of controlling the auxiliary device so as to minimize the adverse affect of the failure given to engine torque control. This enables the engine to operate in further improved controllability during the occurrence of the failure than that achieved with the gradual change control mode being maintained in a fixed changing speed. However, it is needless to say that for a control logic to be simplified, the present invention may adopt a control method of performing the gradual change control mode at a fixed changing speed.

With the control system for the engine of the present embodiment, furthermore, the auxiliary device may preferably comprise an alternator, and the auxiliary device control means may preferably alter a control mode to a fixed voltage control mode so as to control an electric power generated by the alternator such that a charge voltage of a battery, charged with the alternator, is fixed at a target charge voltage.

With such a switching control, the fixed voltage control mode is selected in the presence of the failure in which no collaboration exists between drive torque of the alternator and engine torque. This minimizes the adverse affect of the failure given to engine torque control.

With the control system for the engine of the present embodiment, moreover, the auxiliary device control means may preferably include means for executing, in addition to the fixed voltage control mode, a gradual change control mode for varying drive torque of the alternator at a slower rate than that achieved in a normal mode during variation in a demanded power-generating torque, and the auxiliary device control means may preferably switch the fixed voltage control mode and the gradual change control mode depending on a severity of the failure being detected with the failure detecting means.

With such a switching control, the fixed voltage control mode is selected in the presence of a mild failure while selecting the gradual change control mode in the presence of a fatal failure in which the fluctuation in drive torque of the alternator is restricted. Thus, the drive control mode of the alternator can be switched depending on the severity of the failure being detected, enabling the improvement in controllability of the alternator during the occurrence of the failure in the operating parameter.

With the control system for the engine of the present embodiment, further, the auxiliary device control means may preferably switch the fixed voltage control mode and the gradual change control mode depending on the severity of the failure, detected with the failure detecting means, and engine operating conditions.

With such operation, the fixed voltage control mode and the gradual change control mode can be properly switched based on, in addition to the severity of the failure being detected, the engine operating conditions, enabling the improvement in controllability of the alternator during the occurrence of the failure in the operating parameter.

With the control system for the engine of the present embodiment, furthermore, failure detecting means is operative to detect at least one of operating parameters related to an engine body, a fuel injection system, an evaporator gas purging system, a throttle system, an idling speed control system, an actuating valve drive system, an intake-air volume sensor, an intake-air pressure sensor, an exhaust gas recirculation system, an exhaust gas sensor and an ignition system. This is because these operating parameters form factors that adversely affect engine torque control.

A second aspect of the present invention provides a method of controlling an engine for a vehicle which has an auxiliary device driven with an output torque of the engine, the method comprising starting up the engine, initiating an operation of the auxiliary device with the torque output from the engine, executing a drive control of the auxiliary device so as to vary a drive torque thereof, executing a torque control of the engine to vary the output torque thereof, detecting a failure in an operating parameter, related to the engine, which adversely affects the torque control and altering the drive control of the auxiliary device when the failure is detected.

With such an engine control method, the failure related to the operating parameter adversely affecting engine torque control is detected. Then, at a time instant when the failure is detected, the drive control of the auxiliary device is altered. This makes it possible to minimize the adverse affect given to the engine control. Thus, the auxiliary device can be driven while minimizing the adverse affect of the failure given to engine torque control. This enables the engine to operate in improved controllability to achieve high performance for driving the vehicle in a comfortable manner.

### BRIEF DESCRIPTION OF THE DRAWINGS

FIG. 1 is a block diagram showing an overall structure of an engine control system of a first embodiment according to the present invention.

FIG. 2 is a block diagram illustrating a function of a control system forming part of the engine control system shown in FIG. 1.

FIG. 3 is a view showing a control map representing the relationship between a severity of a failure and a control mode.

FIG. 4 is a view illustrating the relationship between targeted component parts for a failure to be diagnosed and control modes to be executed in the engine control system of the first embodiment shown in FIG. 1.

FIG. 5 is a flowchart showing a basic sequence of operations of one example of an alternator control routine to be executed in the engine control system of the first embodiment shown in FIG. 1.

FIG. 6 is a flowchart showing a basic sequence of operations of a collaborative control routine to be executed in the engine control system of the first embodiment shown in FIG. 1.

FIG. 7 is a flowchart showing a basic sequence of operations of another example of an alternator control routine to be executed in an engine control system of a second embodiment according to the present invention.

### DETAILED DESCRIPTION OF PREFERRED EMBODIMENTS

Now, engine control systems of various embodiments according to the present invention and a related engine control method are described below in detail with reference to the accompanying drawings. However, the present invention is construed not to be limited to such embodiments described below and technical concepts of the present invention may be implemented in combination with other known technologies or the other technology having functions equivalent to such known technologies.

### First Embodiment

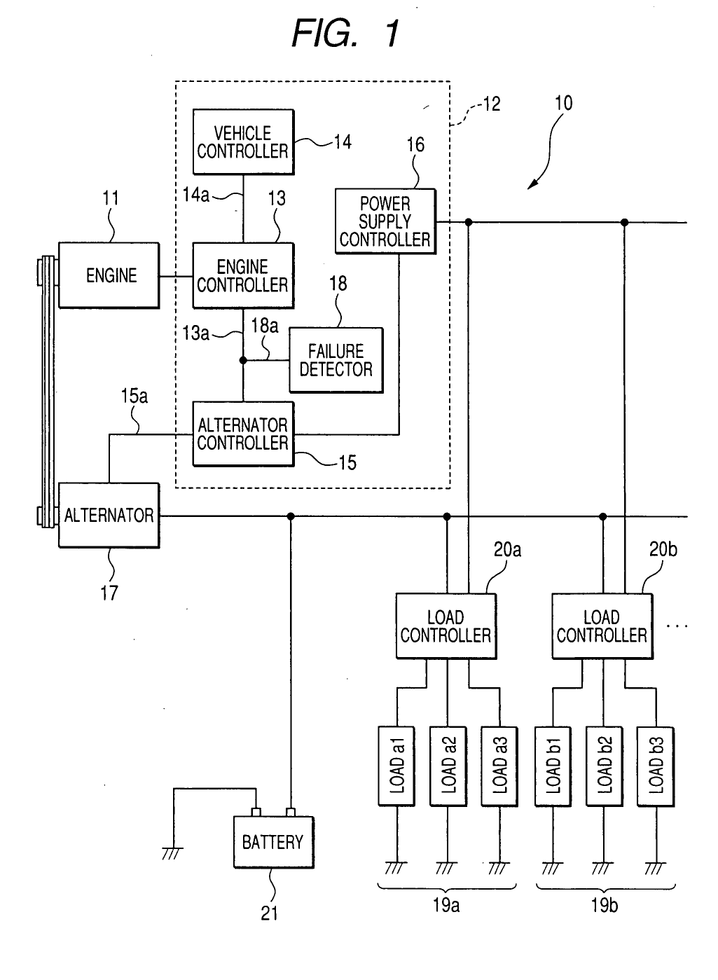

Now, an overall structure of an engine control system of a first embodiment according to the present invention will be described below in detail with reference to FIG. 1.

As shown in FIG. 1, the engine control system 10 is applied to an internal combustion engine 11 for a vehicle that includes various systems such as an air-intake system, a fuel injection system and an ignition system. The engine control system 10 includes a control device 12 for controlling the internal combustion engine 11 and an alternator 17 playing a role as an auxiliary device.

The engine control device 12 includes an engine controller 13 connected to the air-intake system, the fuel injection system and the ignition system of the engine 11 for controlling these component parts depending on a vehicle condition. The engine control device 12 includes, in addition to the engine controller 13, a vehicle controller 14, an alternator controller 15 playing a role as an auxiliary-device controller, a power supply controller 16 and a failure detector 18, all of which are electrically connected to each other via signal lines 13a to 16a.

The vehicle controller 14 calculates engine torque (hereinafter referred to as “demanded vehicle drive torque”) as output torque of the engine 11 required for the vehicle to run and transmits information indicative of such demanded vehicle drive torque to the engine controller 13.

Among auxiliary devices adapted to be driven with engine torque, an electric power generator (alternator) 17 is controlled with the alternator controller 15 and operates so as to generate an electric power at a given power rate. The alternator controller 15 receives permit power-generating torque transmitted from the engine controller 13 to control an excitation current flowing through a field coil of the alternator 17 in response to permit power-generating torque. This allows the alternator 17 to be controlled so as to generate electric power at a desired power rate.

The power supply controller 16 is connected to the alternator controller 15 and first and second load controllers 20a, 20b. The first load controller 20a controls loads a1 to a3 acting as electrical loads 19a, and the second load controller 20b controls loads b1 to b3 acting as electrical loads 19b. The power supply controller 16 detects operating states (representing information related to electric power consumptions) of the electrical loads 19a, 19b and a state of charge (SOC) in a battery 21. The power supply controller 16 then calculates the power rate (hereinafter referred to as “demanded electric power”) of electric power required for the alternator 17 to be driven. In addition, the power supply controller 16 also functions as a demanded power-generating torque calculator, playing a role as demanded auxiliary-device drive-torque calculating means, for calculating drive torque (hereinafter referred to as “demanded power-generating torque) required for the alternator 17 to be driven depending on demanded electric power.

These four controllers 13 to 16 may be incorporated in discrete microcomputers (ECUs). In an alternative, a single microcomputer (ECU) may be adopted to have functions of more than two controllers.

Meanwhile, the failure detector 18 has a self-diagnosing function for detecting a failure in an operating parameter of an engine with a fear of adversely affecting engine torque control being executed with the engine controller 13. For instance, the failure detector 18 detects at least one of failures in operating parameters related to a body of the engine 11, a fuel injection system, an evaporating gas purging system, a throttle system, an idling speed control system (ISC), an actuating valve driving system, an intake-air volume sensor, an intake-air pressure sensor, an exhaust gas recirculation system (EGR), an exhaust gas sensor and an ignition related system. The failure detector 18 monitors the operating states of such component parts, each serving as an object whose failure is to be diagnosed, during the operation of the engine 11. When a particular operating state is in disorder from a normal range, the failure detector 18 detects that a “failure” occurs in the operating state and makes a diagnosis on a severity of the relevant failure.

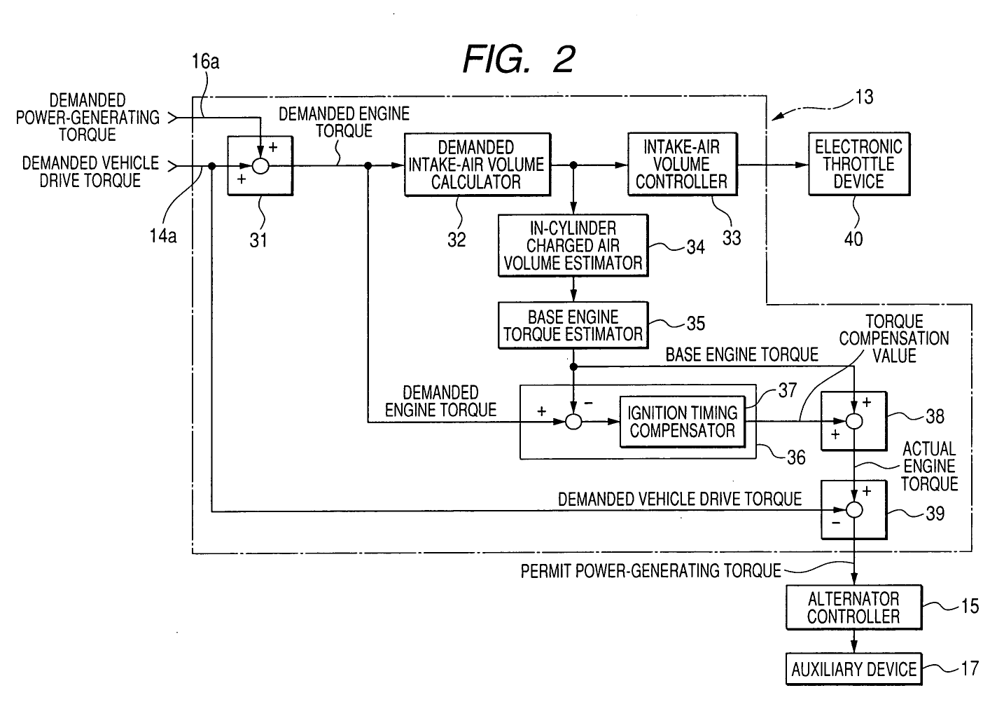

Next, a reference is made to FIG. 2 to describe a collaborative control to be performed for the alternator 17 and the engine 11.

The engine controller 13 has functions as a demanded engine torque calculator 31, a demanded intake-air volume calculator 32, an intake-air volume controller 33, an in-cylinder charged-air volume estimator 34, a base engine torque estimator 35, a torque compensator 36, an ignition timing compensator 37, an actual engine torque estimator 38, and a permit power-generating torque calculator (permit auxiliary-device drive torque calculator) 39.

Here, the demanded engine torque calculator 31 calculates a demanded engine torque by adding demanded vehicle drive torque, calculated by the vehicle controller 14, to demanded power-generating torque (demanded power-generating drive torque) calculated by the power supply controller 16.

The demanded intake-air volume calculator 32 calculates an intake-air volume (hereinafter referred to as a “demanded intake-air volume”) required for the engine 11 to generate demanded engine torque. The intake-air volume controller 33 calculates a demanded throttle opening depending on the demanded intake-air volume for controlling a throttle valve of an electronic throttle device 40 to variably control an intake-air volume required for the engine 11.

The in-cylinder charged-air volume estimator 34 preliminarily stores therein data related to an intake-air system model simulated in terms of a behavior of intake-air sucked into the cylinder after passing across the throttle valve. Thus, the in-cylinder charged-air volume estimator 34 estimates an actual air volume (in-cylinder charged-air volume) sucked into the cylinder by inputting the demanded intake-air volume to data of the intake-air system model.

The base engine torque estimator 35 estimates engine torque (hereinafter referred to as “base engine torque”) to be generated based on the estimated in-cylinder charged-air volume. During such estimating operation, base engine torque estimator 35 estimates base engine torque on consideration of, in addition to the estimated in-cylinder charged-air volume, an ignition timing and/or a fuel injection quantity that are preset according to the engine operating conditions. In short, any one of the in-cylinder charged-air volume, the ignition timing and the fuel injection quantity plays a role as a major parameter for engine torque to vary. Therefore, estimating base engine torque based on these parameters enables base engine torque to be estimated with increased precision.

The torque compensator 36 calculates a deviation (equivalent to a shortage in torque due to a delay in response caused in the air-intake system) between demanded engine torque and base engine torque. Then, the torque compensator 36 allows the ignition timing compensator 37 to calculate a compensation value for the ignition timing based on such a deviation to compensate the ignition timing, thereby correcting engine torque.

The torque compensator 36 includes ignition timing compensation guard means (not shown) with which a compensating limit on the ignition timing is set depending on the engine operating conditions. Thus, the torque compensator 36 allows the compensation value for the ignition timing to be set such that the torque compensation value, obtained by compensating the ignition timing within a range of the compensating limit for the ignition timing, comes close to the deviation (equivalent to the shortage in torque caused by the delay in response of the air-intake system) between demanded engine torque and base engine torque.

The actual engine torque estimator 38 adds the torque compensation value, output from the torque compensator 36, to base engine torque for calculating actual engine torque that can be realized at a subsequent calculating timing. The permit power-generating torque calculator (permit auxiliary-device drive torque calculator) 39 calculates a difference between estimated actual engine torque and demanded vehicle drive torque as permit power-generating torque (permit auxiliary-device drive torque).

The alternator controller 15 controls the excitation current, flowing through the field coil of the alternator 17, depending on the permit power-generating torque calculated in the permit power-generating torque calculator 39 for thereby controlling the alternator 17 such that it generates an electric power at a desired power rate.

With the engine control system 10 of the present embodiment, the alternator controller 15 executes controls in two modes. That is, during a time period in which no failure is detected by the failure detector 18, the alternator controller 15 executes a “collaborative control”. During such collaborative control, the alternator controller 15 executes the operation to control drive torque of the alternator 17 in accordance with engine torque that is controlled with the engine controller 13. In contrast, during another time period in which a failure is detected by the failure detector 18, the alternator controller 15 switches a drive control mode of the alternator 17 between a “gradual pitch control” and a “fixed voltage control” depending on a severity of the failure being detected.

As used herein, the term “gradual pitch control” refers to a control mode in which drive torque of the alternator 17 is gradually varied at a slower pitch than that at which drive torque of the alternator 17 is varied in a normal mode in the absence of a failure. The gradual pitch control may suffice to be achieved by executing at least one of a gradual change in a power rate of generating electric power, a gradual change in an excitation current for electric power to be generated, a gradual change in a duty cycle of a power generating command, and a gradual change in demanded power-generating torque. Meanwhile, the term “fixed voltage control” refers to a control mode in which the alternator 17 is controlled so as to vary a power generating rate such that a charged state of the battery 21, charged with the alternator 17, is fixed at a targeted charge voltage.

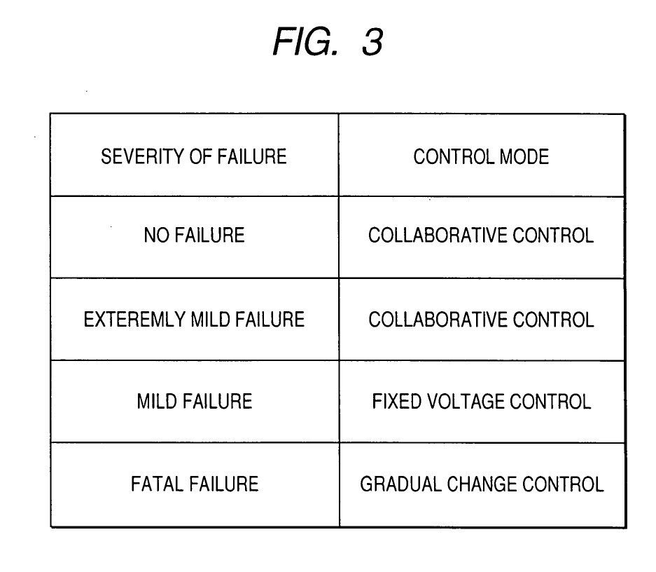

FIG. 3 shows a control map representing the relationship between a severity of a failure and a control mode. In such a control map, the severity of the failure is categorized into four modes such as, for instance, “NO FAILURE”, “EXTREMELY MILD FAILURE”, “MILD FAILURE” and “FATAL FAILURE”. The control mode is categorized into four modes such as, for instance, “COLLABORATIVE CONTROL”, “COLLABORATIVE CONTROL”, “FIXED VOLTAGE CONTROL” and “GRADUAL CHANGE CONTROL”.

In general, drive torque of the alternator 17 adversely affects engine torque control at a rate lessening in a sequence “COLLABORATIVE CONTROL”→“FIXED VOLTAGE CONTROL”→“GRADUAL CHANGE CONTROL”. Thus, the engine controller 13 makes a judgment on the severity (ranging from a minimal level to a fatal level) of the failure based on the rate of such an adverse affect when the failure is detected. During such a judgment, if the severity of the detected failure belongs to “MILD FAILURE”, then, the alternator controller 15 switches the control mode to “FIXED VOLTAGE CONTROL” in which drive torque of the alternator 17 has no collaboration with engine torque. On the contrary, if the severity of the detected failure belongs to “FATAL FAILURE”, then, the alternator controller 15 switches the control mode to “GRADUAL CHANGE CONTROL” (see FIG. 3) in which drive torque of the alternator 17 is varied in a limited range.

With the engine control system 10 of the present embodiment, further, even under a situation where the failure is detected, if the detected failure belongs to “EXTREMELY MILD FAILURE” in which the adverse affect given to engine torque control falls in an allowable range, the alternator controller 15 continuously executes “COLLABORATIVE CONTROL” in the same mode as that executed in a preceding stage in the absence of the detected failure (see FIG. 3).

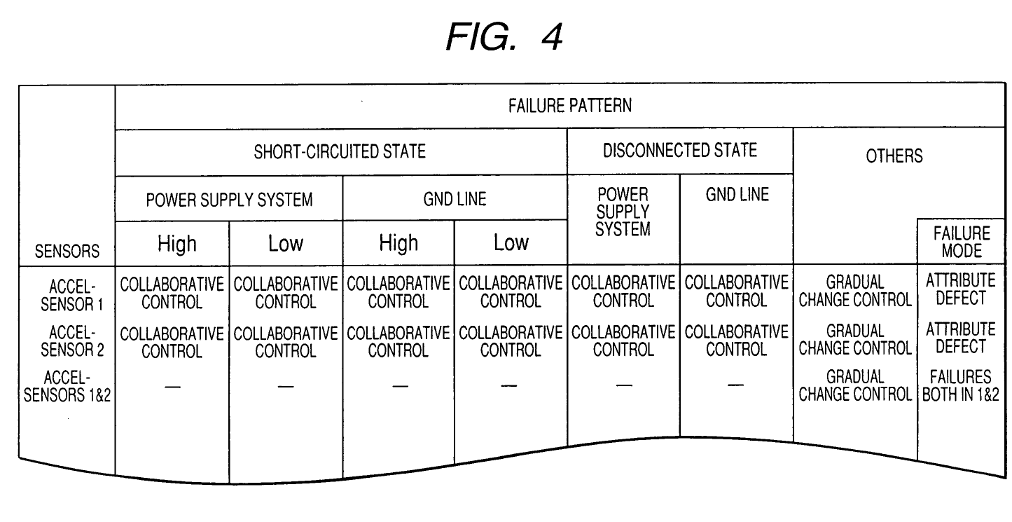

FIG. 4 shows a control map showing how a collaborative control and a gradual change control are executed based on a severity of a detected failure in case of a failure occurring in objects such as sensors to be diagnosed. Examples of the objects include an accel-sensor 1, an accel-sensor 2, accel-sensors 1 and 2 and a throttle sensor 1. The failure modes are categorized into a short-circuited mode, a disconnected mode and others. The short-circuited mode is further classified into a failure in a power supply system and a failure in a GND line. The disconnected mode is classified into a failure in a power supply system and a failure in a GND line. In the presence of failures in the power supply system and the GND line in both the short-circuit mode and the disconnected mode, “COLLABORATIVE CONTROL” is carried out for the accel-sensors 1 and 2. No “COLLABORATIVE CONTROL” is carried out for the accel-sensors 1 and 2 and the accel-sensors 1 & 2 in the failure related to the others. That is, “GRADUAL CHANGE CONTROL” is carried out in the presence of the failure related to the others for the accel-sensors 1 and 2, the accel-sensors 1 & 2 and the throttle sensor 1. In addition, a failure mode is categorized into “ATTRIBUTE DEFECT” and “FAILURES BOTH IN 1 & 2”.

As shown in FIG. 4, the alternator controller 15 makes a judgment on the severity of the detected failure for each objective component part whose failure is to be diagnosed to switch the control mode of the alternator 17 depending on the diagnosed severity of the failure. For instance, for detecting an accel-opening (throttle opening), accel-sensors are provided in two systems with a view to having an increased fail-safe protection.

Therefore, even if a short-circuited state or a disconnected state occurs on the power supply system or GND line for only one of the two accel-sensors, the rest of the accel-sensors can detect the accel-opening. When this takes place, a judgment is made that the severity of the failure belongs to “EXTREMELY MILD FAILURE” and the alternator controller 15 continues to execute “COLLABORATIVE CONTROL” in the same mode as that executed in a preceding stage in the absence of the detected failure.

On the contrary, if both the two accel-censors encounter either the short-circuited state or the disconnected state in the associated power supply system or GND line, the detection of the accel-opening is disenabled in operation. When this takes place, a judgment is made that the severity of the failure belongs to “FATAL FAILURE” and the control mode of the alternator 17 is switched to “GRADUAL CHANGE CONTROL”.

Moreover, if a failure is detected in an output characteristic of even either one of the two accel-sensors, a probability takes place for the accel-opening to be wrongly detected. When this takes place, a judgment is made that the severity of the failure belongs to “FATAL FAILURE” and the control mode of the alternator 17 is switched to “GRADUAL CHANGE CONTROL”.

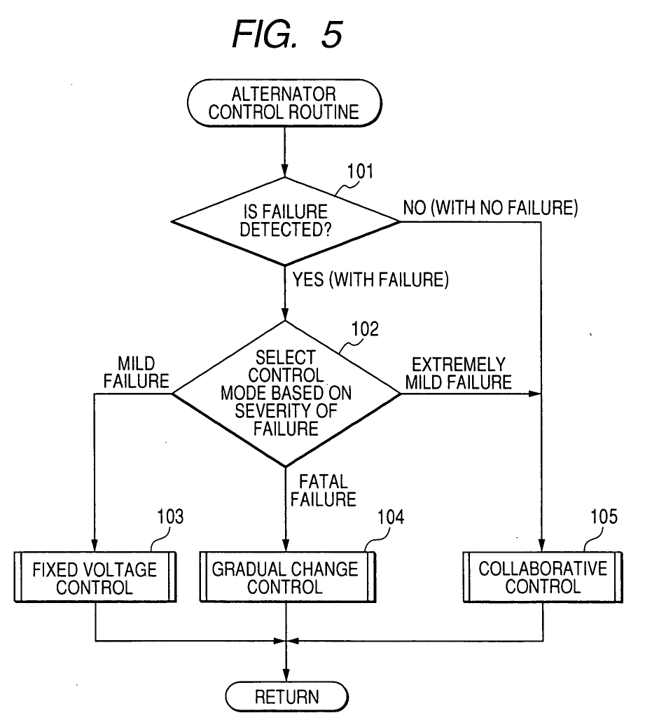

In operation, the alternator 17 is controlled upon executing operations according to an alternator control routine shown in FIG. 5. The alternator control routine, shown in FIG. 5, is executed for a given cycle of, for instance, at a frequency of 32 ms (milliseconds) during the operation of the engine 11.

As the current routine is initiated, first in step 101, a judgment is made whether or not the failure detector 18 detects a failure (such as, for instance, a failure in the body of the engine 11, a failure in the fuel injection system, a failure in the evaporating gas purging system, a failure in the throttle system, a failure in the idling speed control system (ISC), a failure in the actuating valve driving system, a failure in the intake-air volume sensor, a failure in the intake-air pressure sensor, a failure in the exhaust gas recirculation system (EGR), a failure in the exhaust gas sensor and a failure in the ignition system) that adversely affects engine torque control.

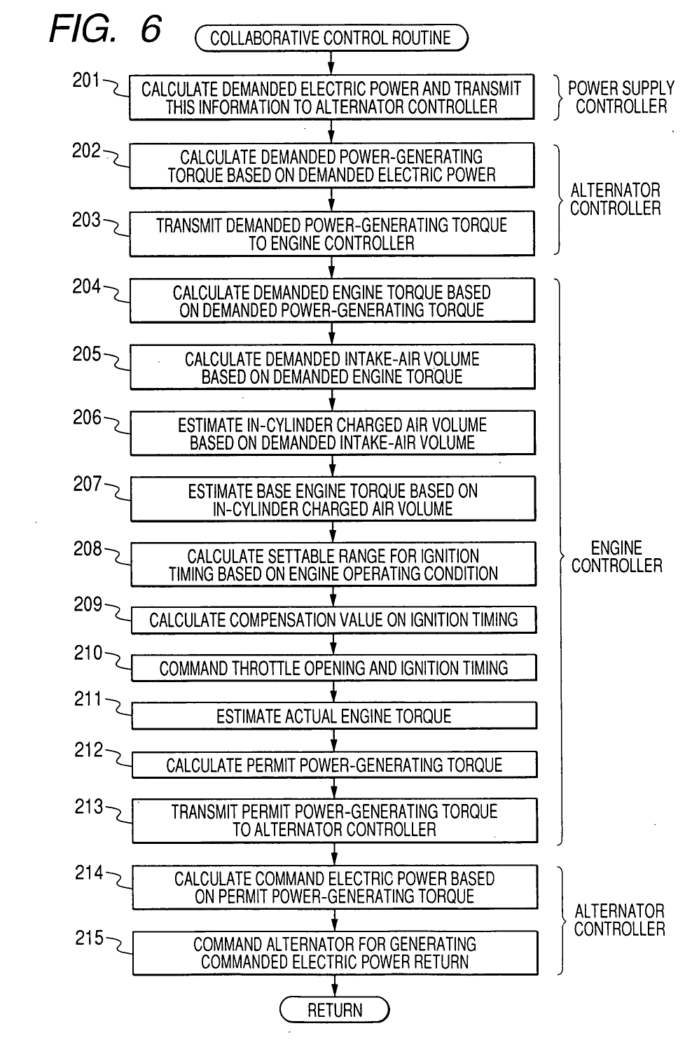

If no failure is detected, the operation proceeds to step 105 in which a collaborative control routine is executed according to a collaborative control routine shown in FIG. 6. Thus, drive torque of the alternator 17 is varied in collaborative control in accordance with engine torque controlled with the engine controller 13.

In contrast, if the failure is detected in step S101, the operation goes to step 102. In this moment, a judgment is made on the severity of the detected failure to select the control mode depending on the severity of the detected failure. For instance, if the severity of the failure belongs to “EXTREMELY MILD FAILURE” under which an adverse affect given to engine torque control falls in an allowable range, the operation proceeds to step S105. In this moment, the alternator controller 15 continues to execute “COLLABORATIVE CONTROL” in the same mode as that achieved in a preceding stage in the absence of the detected failure.

Further, if the severity of the failure belongs to “MILD FAILURE”, then, the operation goes to step 103 and the alternator controller 15 switches the control mode to “FIXED VOLTAGE CONTROL” in which drive torque of the alternator 17 has no collaboration with engine torque. During operation in “FIXED VOLTAGE CONTROL”, the alternator controller 15 allows the alternator 17 to generate an electric power in a feedback control such that a charged voltage of the battery 21, charged with the alternator 17, is fixed at a target charge voltage. During such feedback control, drive torque of the alternator 17 may be adjusted to minimize an adverse affect given to engine torque such that the more severe the severity of the failure, the lower will be the target charge voltage to be regulated in an allowable range of the charge voltage of the battery 21.

Further, if the severity of the failure belongs to “FATAL FAILURE”, then, the operation proceeds to step 104, in which the alternator controller 15 switches the control mode to “GRADUAL CHANGE CONTROL” for regulating drive torque of the alternator 17 within a limited range. During such “GRADUAL CHANGE CONTROL”, for variation in demanded power-generating torque (permit power-generating torque), drive torque of the alternator 17 is gradually varied at a slower pitch than that at which drive torque of the alternator 17 is controlled in a normal mode. “GRADUAL CHANGE CONTROL” may suffice to be achieved upon executing at least one of a gradual change in generated electric power, a gradual change in the excitation current flowing through the field coil of the alternator 17 for generating electric power, a gradual change in the duty cycle of the power-generating command and a gradual change in demanded power-generating torque. During such gradual pitch control, drive torque of the alternator 17 may be adjusted to minimize an adverse affect given to engine torque such that the more severe the severity of the failure, the slower will be the gradual change speed of the gradual change control mode to be executed.

FIG. 6 shows a basic sequence of operations in carrying out the collaborative control routine as a subroutine to be executed in step 205 in the alternator control routine shown in FIG. 5.

As the current routine is initiated, first in step 201, the power supply controller 16 calculates the rate of electric power (demanded electric power), required for the alternator 17 to generate, based on the operating states (in terms of electric power consumptions) of the electrical loads 19a, 19b received from the load controller s 20a, 20b and the state of charge in the battery 21 and transmits information on demanded electric power to the alternator controller 15.

In subsequent step 202, the alternator controller 15 calculates torque (demanded power-generating torque) required for the alternator 17 to be driven depending on demanded electric power mentioned above using the alternator model. As used herein, the term “alternator model” refers to a model based on which power-generating torque is calculated as a function of parameters including electric power (demanded electric power) being generated by the alternator 17, a rotating speed of the alternator 17 (or an engine speed), and a bus line voltage of the power supply, etc. In succeeding step 203, the alternator controller 15 transmits information on demanded power-generating torque to the engine controller 13.

Subsequently, in step 204, the engine controller 13 calculates demanded engine torque equivalent to a sum of demanded power-generating torque, calculated by the alternator controller 15, and demanded vehicle drive torque calculated by the vehicle controller 14. In next step 205, the engine controller 13 calculates an intake-air volume (demanded intake-air volume) required for the engine 11 to generate demanded engine torque, after which the operation proceeds to step 206. In this moment, the engine controller 13 estimates an actual air volume (in-cylinder charged-air volume) sucked into the cylinder upon inputting the demanded intake-air volume to an intake-air system model in which a delay in response of an air-intake system is simulated. In subsequent step 207, the engine controller 13 estimates base engine torque with the account for the ignition timing and/or the fuel injection quantity that are preliminarily set depending on the operating conditions of the engine 11.

In next step 208, the engine controller 13 calculates an ignition-timing settable range (compensating limit on ignition timing) based on the current engine operating conditions such as, for instance, the engine speed and the load by referring to a map or the like.

In succeeding step 209, the torque compensator 36 calculates a deviation (equivalent to a shortage in torque due to a delay in response of the air-intake system) between demanded engine torque and base engine torque. Then, the torque compensator 36 allows the ignition timing compensator 37 to calculate a compensation value on the ignition timing within the ignition-timing settable range (compensating limit on ignition timing) based on the deviation between demanded engine torque and base engine torque such that a torque compensating quantity, resulting from the compensated ignition timing, becomes close to the deviation (equivalent to the shortage in torque caused by the delay in response of the air-intake system) between demanded engine torque and base engine torque. In subsequent step 210, the engine 11 is commanded to achieve a compensated throttle opening for realizing demanded engine torque and a compensated ignition timing based on the compensation value on ignition timing.

In succeeding step 211, upon adding the torque compensation value resulting from the compensation on ignition timing to base engine torque, the actual engine torque calculator 38 estimates actual engine torque to be realized in subsequent calculation timing. In next step 212, the permit power-generating torque calculator 39 calculates a deviation between estimated engine torque and demanded vehicle drive torque as permit power-generating torque. In consecutive step 213, the engine controller 13 transmits information on such permit power-generating torque to the alternator controller 15.

In succeeding step 214, the alternator controller 15 calculates the rate of electric power, corresponding to permit power-generating torque, as command electric power.

In subsequent step 215, the alternator controller 15 controls the excitation current of the alternator 17, which in turn generates electric power at a rate equivalent to command electric power.

Meanwhile, during the collaborative control being executed, demanded electric power increases in a stepwise fashion. In this moment, demanded power-generating torque, demanded engine torque and demanded intake-air volume (throttle opening) also increase in a stepwise fashion. Under such conditions, a variation in the throttle opening (variation in a volume of air passing across the throttle) appears as a variation in engine torque (variation in in-cylinder charged-air volume) with a delay in response of the intake-air system, that is, a delay in intake air passing across the throttle valve and sucked into the cylinder.

To address such a delay in response, during the collaborative control being executed, the ignition timing is compensated in consideration of the delay in response in the air-intake system at timing in which demanded electric power increases in a stepwise fashion. However, a limitation exists in the magnitude of torque available to be ensured upon compensating the ignition timing. Also, under a situation where the engine is operating with the ignition timing controlled in the vicinity of a knocking limit and a stable combustion limit, the ignition timing has an extremely narrow allowable compensating range and there is a less torque compensation value that can be incremented or decremented upon compensating the ignition timing. Thus, when a remarkable variation rapidly takes place in demanded electric power (demanded power-generating torque), a shortage occurs in the torque compensation value for a rapid variate on demanded power-generating torque even if both the intake-air volume and the ignition timing are compensated.

As a measure to counter this, the engine control system 10 of the present embodiment executes the collaborative control in a featuring process described below. That is, an in-cylinder charged-air volume is estimated in consideration of a delay in response in the air-intake system, thereby estimating base engine torque depending on the estimated in-cylinder charged-air volume. Then, the ignition timing is compensated based on the deviation (equivalent to the shortage in torque caused by the delay in response of the air-intake system) between the demanded engine torque and base engine torque. Then, the operation is executed to calculate the torque compensation value that can be obtained upon compensating the ignition timing. During such calculation, the torque compensating value is added to base engine torque to estimate an actual engine torque. Then, the operation is executed to calculate a difference between the estimated actual engine torque and the demanded vehicle drive torque as a permit power-generating torque, upon which the alternator 17 is driven with such permit power-generating torque. By so doing, even if the rapid variate occurs in demanded electric power (demanded power-generating torque), drive torque of the alternator 17 can be restricted with permit power-generating torque such that the vehicle is driven with demanded vehicle drive torque. This prevents the vehicle from accelerating or decelerating due to fluctuation in engine speed caused by rapid variation in demanded electric power (demanded power-generating torque) and against a driver's will.

With the engine control system 10 of the present embodiment, further, the collaborative control is executed in another featuring process. That is, the compensating limit on ignition timing is set to a value depending on the engine operating conditions. The compensating value on ignition timing is set to lie in a range for the compensating limit on ignition timing such that the torque compensating value, resulting from compensated ignition timing, gets close to the deviation (equivalent to the shortage in torque caused by the delay in response of the air-intake system) between demanded engine torque and base engine torque. This enables permit power-generating torque to get close to demanded power-generating torque within the range of the compensating limit on ignition timing. Thus, the engine 11 can have an increased response in demanded power-generating torque within the range of the compensating limit on ignition timing.

Meanwhile, if a failure occurs in a system such as the fuel injection system, the ignition system and the air-intake system or the like for controlling engine torque, engine torque cannot be controlled in a normal manner. Under such a failed status, if the collaborative control is continuously executed, defective operation takes place during an idling operation of the engine with the resultant occurrence of a remarkable increase in fluctuation on engine speed or occurrence of engine stall. This results in a cause for the vehicle to accelerate or decelerate against the driver's will during a traveling of the vehicle.

With the present embodiment, therefore, when a failure occurs giving an adverse affect to engine torque control, the failure detector 18 detects such a failure. At this moment, the engine control system 10 alters the drive control of the alternator 17 to a control mode (in “FIXED VOLTAGE CONTROL” or “GRADUAL CHANGE CONTROL”) so as to minimize the adverse affect of the failure given to engine torque control. This enables the alternator 17 to be driven with minimized adverse affect given to engine torque control during the occurrence of the failure.

With the present embodiment, further, the engine control system 10 has a structure to switch the fixed voltage control mode and the gradual change control mode depending on the severity of the failure being detected with the failure detector 18. This makes it possible to switch the drive control of the alternator 17 depending on the severity of the detected failure such that when a mild failure is detected, the fixed voltage control mode is selected and when a fatal failure is detected, the gradual change control mode is selected. This restricts the fluctuation in drive torque of the alternator 17. Thus, the alternator 17 can have improved controllability during the occurrence of the failure.

In an alternative, however, the present invention may be modified so as to execute only either one of the fixed voltage control mode and the gradual change control mode without making a judgment on the severity of the detected failure. In a case where only the gradual change control mode is executed in the presence of the detected failure, for instance, the gradual change control mode may be executed at a fixed gradual change speed with a view to simplifying control logic.

In an alternative, the gradual change speed of the gradual change control mode may be varied depending on the severity of the failure detected with the failure detector 18. By so doing, a control can be executed such that the more severe the severity of the detected failure, the slower will be the gradual change speed of the gradual change control mode. This results in less occurrence of an adverse affect given to engine torque. Thus, the engine 11 can have farther improved controllability during the occurrence of the failure than that achieved in a case where the gradual change control modes is executed at the fixed gradual change speed.

Further, in another case where only the fixed voltage control mode is executed in the presence of the detected failure, the target charge voltage of the battery 21 may be altered depending on the severity of the failure detected with the failure detector 18. With such alteration, it becomes possible to perform a control so as to minimize the adverse affect given to engine torque such that the more severe the severity of the detected failure, the lower will be the target charge voltage of the battery 21 within an allowable charge voltage range thereof. This enables further improved controllability to be obtained during the occurrence of the failure than that achieved in a case where the target charge voltage is fixed.

### Second Embodiment

With the engine control system 10 of the first embodiment mentioned above, the control mode is switched between the fixed voltage control mode and the gradual change control mode depending on the severity of the failure being detected with the failure detector 18. However, the control mode may be switched between the fixed voltage control mode and the gradual change control mode depending on the severity of the failure, detected with the failure detector 18, and the engine operating conditions.

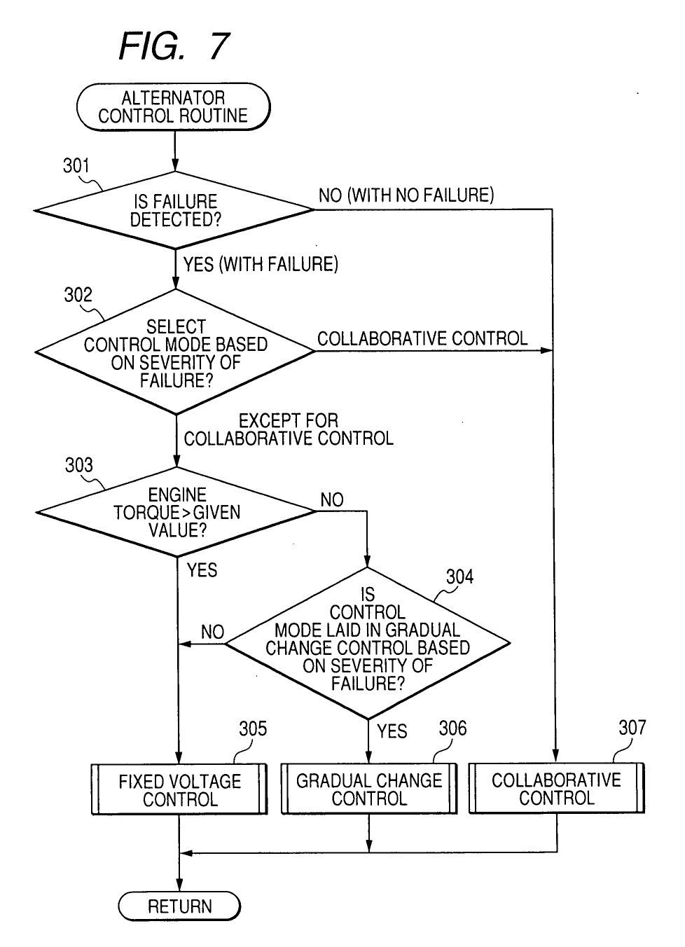

An engine control system of a second embodiment implementing such a concept is described below with reference to FIG. 7 showing an alternator control routine to be used in the second embodiment. The engine control system of the second embodiment has the same structure as that achieved in the first embodiment except for the alternator control routine shown in FIG. 7 and, therefore, the same component parts as those of the engine control system of the first embodiment bear like reference numerals to describe the present embodiment with a focus on the alternator control routine shown in FIG. 7.

As the current control routine is initiated, first in step S301, a judgment is made whether or not the failure detector 18 detects a failure giving an adversely affect to engine torque control.

If no failure is detected, the operation proceeds to step 307 in which the collaborative control routine, shown in FIG. 6, is executed. This allows the collaborative control to be performed to vary drive torque of the alternator 17 in conformity to engine torque being controlled with the engine controller 13.

In contrast, if the failure is detected in step S301, the operation goes to step 302. In this moment, a judgment is made on the severity of the detected failure to select a control mode depending on the severity of the detected failure. In this case, if the severity of the failure belongs to “EXTREMELY MILD FAILURE” under which the adverse affect given to engine torque control falls in an allowable range, the operation proceeds to step 307. In this moment, the control mode is continuously executed in “COLLABORATIVE CONTROL” on the same mode as that achieved in a preceding stage in the absence of the failure.

Further, if the severity of the failure belongs to “MILD or FATAL FAILURE”, then, the operation goes to step 303. In this moment, a comparison is made between engine torque, representing typical information on the engine operating conditions, and a given value. If engine torque is greater than the given value, then, a judgment is made that engine torque has a margin to some extent and the adverse affect given to engine torque control caused by the fluctuation in drive torque of the alternator 17 resulting from the fixed voltage control mode lies in an allowable range. Thus, the operation proceeds to step 305, in which the control mode is switched to “FIXED VOLTAGE CONTROL” regardless of the severity of the detected failure. By so doing, even under a situation where a fatal failure is present in the system, if engine torque is greater than the given value, then, the control mode is switched not to “GRADUAL CHANGE CONTROL” but to “FIXED VOLTAGE CONTROL” in contrast to the control mode executed in the first embodiment, causing the battery 21 to be maintained at a fixed charge voltage. Such “FIXED VOLTAGE CONTROL” may be executed in the same method as that achieved in the first embodiment.

Further, in step 303, if a judgment is made that engine torque is less than the given value, then, a judgment is made that the fluctuation in drive torque of the alternator 17 has a relatively large adverse affect given to engine torque control. In this moment, the operation proceeds to step 304 wherein a judgment is made whether or not the control depending on the severity of the failure lies in “GRADUAL CHANGE CONTROL” (that is, whether or not the failure belongs to a fatal failure). If the control depending on the severity of the failure lies in “GRADUAL CHANGE CONTROL”, then, the operation proceeds to step 306. In this moment, the control mode is switched to “GRADUAL CHANGE CONTROL” so as to restrict the fluctuation in drive torque of the alternator 17. Such “GRADUAL CHANGE CONTROL” may be executed in the same method as that achieved in the first embodiment.

Furthermore, if a judgment is made with “No” in step 304, then, a judgment is made that the control depending on the severity of the failure lies in “FIXED VOLTAGE CONTROL” (representing the presence of a mild failure). In this moment, the operation proceeds to step 305, in which the control mode is switched to “FIXED VOLTAGE CONTROL”. Thus, under a situation where engine torque is less than the given value, the engine control system 10 executes “FIXED VOLTAGE CONTROL” in the presence of a mild failure and “GRADUAL CHANGE CONTROL” in the presence of a fatal failure in the same operation as that achieved in the first embodiment.

With the engine control system 10 of the second embodiment set forth above, the control mode is switched between the gradual change control mode and the fixed voltage control mode depending on the severity of the failure being detected with the failure detector 18 and engine torque. This enables the gradual change control mode and the fixed voltage control mode to be more properly switched with the account for, in addition to the severity of the failure, engine torque. Thus, even in the presence of a fatal failure, if engine torque has a margin, then, the fixed voltage control mode is executed to allow the battery 21 to be maintained at a fixed charge voltage. This enables the alternator 17 to have further improved controllability (for voltage charging performance of the battery 21) during the occurrence of the failure.

With the engine control system of the second embodiment, engine torque has been used as information representing the engine operating condition. In place of such information, any one of, for instance, an intake-air volume, an intake manifold pressure, a throttle opening, an accel-opening, and an engine speed, etc., may be used as information representing the engine operating condition. Thus, the fixed voltage control mode and the gradual change control mode may be switched depending on information representing any of such engine operating conditions and the severity of the failure.

In an alternative, a judgment may be made on an engine operating region by referring to a map or the like employing more than two parameters as information representing the engine operating conditions. Then, the control mode may be switched between the fixed voltage control mode and the gradual change control mode depending on the engine operating region and the severity of the failure.

Furthermore, with the engine control systems of the first and second embodiments set forth above, the collaborative control, executed in the absence of the detected failure, is not limited to the control based on the collaborative control routine shown in FIG. 6. That is, the operation may be executed in another way such that drive torque of the alternator 17 is controlled in accordance with engine torque controlled with the engine controller 13.

Moreover, the engine control systems of the first and second embodiments set forth above are directed to the structures in which the present invention is applied to the system for controlling engine torque control and the drive control of the alternator 17 in collaboration. However, the present invention may be applied to a system in which an auxiliary device (such as, for instance, any one of an air-conditioning compressor, a compressor for a power steering, and a motor generator), except for the alternator 17, and engine torque control are collaborated. It is, of course, needless to say that the present invention may be applied to a system for collaborating more than two auxiliary devices and engine torque control.

While the specific embodiments of the present invention have been described in detail, the present invention is not limited to the particularly illustrated structures of the gas sensors of the various embodiment set forth above provided that the measuring gas side covers achieve the task of the present invention. It will be appreciated by those skilled in the art that various modifications and alternatives to those details could be developed in light of the overall teachings of the disclosure.

What is claimed is:

1. A control system for an engine with an auxiliary device, driven with an output torque of the engine, for driving a vehicle, the control system comprising:
auxiliary device control means for controlling a drive torque of the auxiliary device;
engine control means for executing an engine torque control to vary the output torque of the engine; and
failure detecting means for detecting a failure, related to an operating parameter of the engine, which adversely affect engine torque control being executed with the engine control means;
wherein the auxiliary device control means alters a drive control of the auxiliary device in response to the failure detected with the failure detecting means.

2. The control system for an engine according to claim 1, wherein:
the auxiliary device includes at least one of an alternator, an air-conditioning compressor, a power-steering compressor and a motor generator.

3. The control system for an engine according to claim 1, wherein:
the auxiliary device control means performs a collaborative control for varying drive torque of the auxiliary device in accordance with the output torque of the engine during a time period in which no failure is detected with the failure detecting means.

4. The control system for an engine according to claim 1, wherein:
the auxiliary device control means alters a control mode to a gradual change control mode for varying drive torque of the auxiliary device at a slower rate than that achieved in a normal mode during variation in a demanded auxiliary-device drive torque when the failure is detected with the failure detecting means.

5. The control system for an engine according to claim 1, wherein:
the auxiliary device comprises an alternator; and
the auxiliary device control means executes at least one of a gradual change in electric power generated by the alternator, a gradual change in an excitation current of the alternator, a gradual change in a power-generating command duty and a gradual change in a demanded power-generating torque.

6. The control system for an engine according to claim 4, wherein:
the auxiliary device control means alters a gradual change speed of the gradual change control mode depending on a severity of the failure being detected with the failure detecting means.

7. The control system for an engine according to claim 1, wherein:
the auxiliary device comprises an alternator; and
the auxiliary device control means alters a control mode to a fixed voltage control mode so as to control an electric power generated by the alternator such that a charge voltage of a battery, charged with the alternator, is fixed at a target charge voltage.

8. The control system for an engine according to claim 7, wherein:
the auxiliary device control means includes means for executing, in addition to the fixed voltage control mode, a gradual change control mode for varying drive torque of the alternator at a slower rate than that achieved in a normal mode during variation in a demanded power-generating torque; and
the auxiliary device control means switches the fixed voltage control mode and the gradual change control mode depending on a severity of the failure being detected with the failure detecting means.

9. The control system for an engine according to claim 8, wherein:
the auxiliary device control means switches the fixed voltage control mode and the gradual change control mode depending on the severity of the failure, detected with the failure detecting means, and engine operating conditions.

10. The control system for an engine according to claim 1, wherein:
the failure detecting means is operative to detect at least one of operating parameters related to an engine body, a fuel injection system, an evaporator gas purging system, a throttle system, an idling speed control system, an actuating valve drive system, an intake-air volume sensor, an intake-air pressure sensor, an exhaust gas recirculation system, an exhaust gas sensor and an ignition system.

11. The control system for an engine according to claim 1, wherein:
the auxiliary device comprises an alternator for charging a battery; and
further comprising:
power supply control means for detecting a residual charge state of the battery and calculating a demanded power-generating torque based on the residual charge state of the battery; and
wherein the auxiliary device control means controls drive torque of the auxiliary device in response to demanded power-generating torque.

12. The control system for an engine according to claim 1, wherein:
the auxiliary device comprises an alternator for charging a battery; and
further comprising:
vehicle control means for calculating a demanded vehicle drive torque required for the vehicle to run and transmitting information on the demanded vehicle drive torque to the engine control means; and
power supply control means for detecting a residual charge state of the battery and calculating a demanded power-generating torque based on the residual charge state of the battery and transmitting information on demanded power-generating torque to the engine control means; and
wherein the engine control means includes demanded engine torque calculating means for calculating a demanded engine torque to control the output torque of the engine depending on the demanded engine torque to meet the demanded vehicle drive torque and demanded power-generating torque.

13. The control system for an engine according to claim 12, wherein:
the engine has an electronic throttle device for varying a throttle opening of the engine; and
the engine control means is operative to activate the electronic throttle device depending on the demanded engine torque for setting the throttle opening so as to supply the engine with a predetermined intake-air volume to cause the engine to achieve the demanded engine torque.

14. The control system for an engine according to claim 12, wherein:
the engine control means further includes base engine torque estimating means for estimating a base engine torque based on a given engine parameter, actual engine torque estimating means for estimating an actual engine torque based on a torque compensation value and base engine torque, and permit power-generating torque calculating means for calculating a permit power-generating torque depending on the estimated actual engine torque and the demanded vehicle drive torque; and
wherein the auxiliary device control means controls drive torque of the auxiliary device depending on the permit power-generating torque.

15. The control system for an engine according to claim 12, wherein:
the auxiliary device control means comprises alternator control means for controlling the alternator in a gradual change control mode and a fixed voltage control mode depending on the presence of or the absence of the failure being detected with the failure detecting means.

16. A method of controlling an engine for a vehicle which has an auxiliary device driven with an output torque of the engine, the method comprising:
starting up the engine;
initiating an operation of the auxiliary device with the torque output from the engine;
executing a drive control of the auxiliary device so as to vary a drive torque thereof;
executing a torque control of the engine to vary the output torque thereof;
detecting a failure in an operating parameter, related to the engine, which adversely affects the torque control; and
altering the drive control of the auxiliary device when the failure is detected.

17. The method of controlling an engine for a vehicle according to claim 16, wherein:
the auxiliary device includes at least one of an alternator, an air-conditioning compressor, a power-steering compressor and a motor generator.

18. The method of controlling an engine for a vehicle according to claim 16, wherein:
the drive control includes a collaborative control executed to vary drive torque of the auxiliary device in accordance with the output torque of the engine during a time period in the absence of the failure being detected.

19. The method of controlling an engine for a vehicle according to claim 16, wherein:
the step of executing a drive control of the auxiliary device executes the drive control in a gradual change control mode for varying drive torque of the auxiliary device at a slower rate than that achieved in a normal mode in the presence of the failure being detected.

20. The method of controlling an engine for a vehicle according to claim 16, wherein:
the auxiliary device comprises an alternator; and
the step of executing a drive control of the auxiliary device executes at least one of a gradual change in electric power generated by the alternator, a gradual change in an excitation current of the alternator, a gradual change in a power-generating command duty and a gradual change in a demanded power-generating torque.

21. The method of controlling an engine for a vehicle according to claim 19, wherein:
the step of executing a drive control of the auxiliary device alters a speed of the gradual change control mode depending on a severity of the failure being detected.

22. The method of controlling an engine for a vehicle according to claim 16, wherein:
the auxiliary device comprises an alternator; and
the step of executing a drive control of the auxiliary device executes the drive control in a fixed voltage control mode so as to control an electric power generated by the alternator such that a charge voltage of a battery, charged with the alternator, is fixed at a target charge voltage.

23. The method of controlling an engine for a vehicle according to claim 22, wherein:
the step of executing a drive control of the auxiliary device executes the drive control in, in addition to the fixed voltage control mode, a gradual change control mode for varying drive torque of the auxiliary device at a slower rate than that achieved in a normal mode; and
the step of executing a drive control of the auxiliary device switches the fixed voltage control mode and the gradual change control mode depending on a severity of the failure being detected.

24. The method of controlling an engine for a vehicle according to claim 23, wherein:
the step of executing a drive control of the auxiliary device switches the fixed voltage control mode and the gradual change control mode depending on the severity of the failure and engine operating conditions.

25. The method of controlling an engine for a vehicle according to claim 16, wherein:
the step of detecting a failure in an operating parameter detects at least one of operating parameters related to an engine body, a fuel injection system, an evaporator gas purging system, a throttle system, an idling speed control system, an actuating valve drive system, an intake-air volume sensor, an intake-air pressure sensor, an exhaust gas recirculation system, an exhaust gas sensor and an ignition system.

26. The method of controlling an engine for a vehicle according to claim 16, wherein:
the auxiliary device comprises an alternator for charging a battery; and
further comprising:
detecting a residual charge state of the battery;
calculating a demanded power-generating torque based on the residual charge state of the battery; and
controlling drive torque of the auxiliary device in response to demanded power-generating torque.

27. The method of controlling an engine for a vehicle according to claim 16, wherein:
the auxiliary device comprises an alternator for charging a battery; and
further comprising:
calculating a demanded vehicle drive torque required for the vehicle to run;
detecting a residual charge state of the battery;
calculating a demanded power-generating torque based on the residual charge state of the battery;
calculating a demanded engine torque based on demanded power-generating torque; and
the step of executing a torque control of the engine varying the output torque of the engine depending on the demanded engine torque.

28. The method of controlling an engine for a vehicle according to claim 27, wherein:
the engine has an electronic throttle device for operating a throttle valve of the engine; and
the step of executing a torque control of the engine activating the electronic throttle device depending on the demanded engine torque for setting a throttle opening to supply the engine with a predetermined intake-air volume to cause the engine to achieve the demanded engine torque.

29. The method of controlling an engine for a vehicle according to claim 27, wherein:
the step of executing a torque control of the engine comprises estimating a base engine torque based on a given engine parameter, estimating an actual engine torque based on a torque compensation value and base engine torque, and calculating a permit power-generating torque depending on the estimated actual engine torque and a demanded vehicle drive torque; and
the step of executing a drive control of the auxiliary device varies drive torque of the auxiliary device depending on the permit power-generating torque.

30. The method of controlling an engine for a vehicle according to claim 27, wherein:
the step of executing a drive control of the auxiliary device drives the alternator in a gradual change control mode and a fixed voltage control mode depending on the presence of or the absence of the failure being detected.
